(19) United States
(12) Patent Application Publication
(10) Pub. No.: US 2014/0122150 A1
(43) Pub. Date: May 1, 2014

(54) Mobile Device and Task Monitoring

(71) Applicant: Moose Loop Holdings, LLC, Salt Lake City, UT (US)

(72) Inventor: Ken R. Davis, Salt Lake City, UT (US)

(21) Appl. No.: 13/839,500

(22) Filed: Mar. 15, 2013

Related U.S. Application Data
(60) Provisional application No. 61/719,775, filed on Oct. 29, 2012.

(51) Int. Cl. G06Q 10/06

(52) U.S. Cl. CPC G06Q 10/063118
USPC 705/7.17

(57) ABSTRACT

Technology is described for electronically verifying a service provider's presence at a task location. The method may include identifying a task assignment and the associated task details that may be performed for a customer, setting a task price for the task based on the task details, and assigning the task to a service provider willing to perform the task at the task price. A geographic location of the service provider, associated with a timestamp representing the geographic location capture time, then may be captured using a mobile computing device.

### PRIORITY CLAIM

Priority is claimed to U.S. Provisional Patent Application Ser. No. 61/719,775, filed Oct. 29, 2012, which is hereby incorporated herein by reference in its entirety.

### BACKGROUND

Many goods can be purchased in a commoditized way. A consumer can have certain criteria when deciding to purchase goods, and if the goods meet the desired criteria, then the consumer generally cares less about who provides the goods.

Services have traditionally been less commoditized. Rather, services are typically purchased after comparing service providers to one another. For example, service providers can be compared through a bidding process, interviews, and/or online user feedback ratings. Even such service provider comparisons can be challenging for a consumer to interpret due the non-uniformity in services supplied by various service providers. This may result in uncertainty to the consumer as to the comparative cost of services, reliability of services, and the quality of services provided by various service providers.

### BRIEF DESCRIPTION OF THE DRAWINGS

FIG. 1 is a block diagram illustrating an example of a system for verifying service provider presence at a task location.

FIG. 2 illustrates an example of a weekly calendar showing tasks to be performed by a service provider during a time period.

FIG. 3 is a flowchart illustrating of an example method for verifying service provider presence at a task location.

FIG. 4 is another block diagram illustrating an example of a system for verifying service provider presence at a task location.

FIG. 5 illustrates an example of a calendar with scheduling for a specific day.

FIG. 6 illustrates an example of a managed jobs screen showing beginning and end times associated with photographs.

FIGS. 7a-7c illustrate user interface screens for mobile devices depicting functions related to performing tasks.

### DETAILED DESCRIPTION

Reference will now be made to the examples illustrated in the drawings, and specific language will be used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure are to be considered within the scope of the description.

A technology is described for efficiently providing access to services via a networked computer system and verifying that the services were completed within the time period agreed upon and at an expected quality level. More accurate and efficient access to services may commoditize services not traditionally commoditized in the past by allowing the services to be priced and delivered in a more uniform fashion. While access may be provided for any of a nearly limitless number of services provided by service providers, examples of commoditization of services may be applied to many areas including various yard and home services, such as: lawn mowing, lawn fertilizing, basic home repairs, painting, cleaning, gardening, small appliance repair, etc. A service provider can be any service provider, contractor, service contractor, service group, or service supply entity that provides a service to a customer.

This technology may allow a user to select a service or task (e.g., lawn mowing) to be purchased electronically, and a user interface on a client device can present choices to the customer that include task parameters and other details about the service. These service parameters can be used provide efficient commodity-like pricing. The service parameters may include task details or variables that affect pricing and other factors for the task. In a lawn mowing example, parameters may be collected from a customer that include: lawn shape and size, length of grass, type of grass, physical location, quality of service provider desired, need for repeat service, etc. The pricing of the service or task may be a fixed price that is calculated using existing facts about the service and statistical data known about task prices in a geographical area, etc. With iterated services and sufficient service provider and customer feedback, the pricing can become more accurate over time such that each task may become more like a standard unit of work that is priced with increasing accuracy. The terms service and task may be used interchangeably in this description.

Commoditized tasks purchased by a customer through this technology may be matched with one of a plurality of service providers who have schedule availability to perform the task. Customers may have the opportunity to select preferred service providers from a list of available service providers, but the selection of a service provider is optional. A customer may be encouraged to allow the service provider to be assigned automatically using a computing device, and the customer may be encouraged not to select a service provider through various pricing and other inducements. As the services become more commoditized, then the service providers become more easily interchangeable. This may provide an experience similar to a customer's experience in a retail setting where the customer is more interested in the convenience of acquiring goods at a known quality, quantity and/or price, rather than which individual or entity made the goods being purchased.

Service providers can be matched to customers on the basis of a number of additional parameters identified by the service providers and these parameters may include: shortest distance to customer, higher schedule availability, matching skill level, quality level desired, availability of required tools to perform the task, and other parameters. The value provided to service providers may be increased by providing more customers, assigning customers situated closer together, automated pricing, back office accounting and management functions, and other ways that improve service provider efficiency and/or boost service provider revenues.

Using a commodity approach can simplify the service purchase process and can make buying services more analogous to buying tangible goods through a retail store. Detailed methods may be used to compute a fair market pricing for the service based on customer provided specifications about the service to be performed. The fair market pricing can allow a fixed price to be presented to the customer, at the point of sale, and allow the customer to complete a transaction immediately.

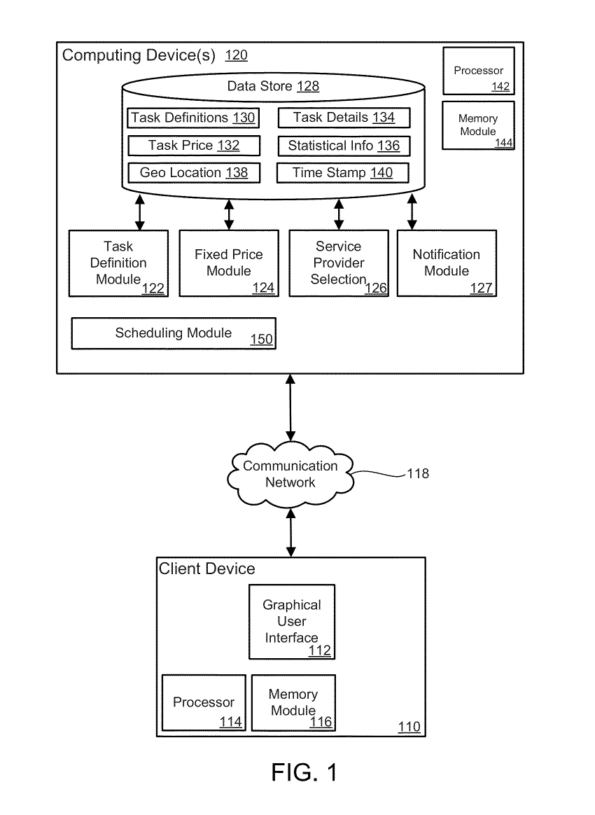

As illustrated in FIG. 1, a system can be used for delivering, pricing, assigning, managing and exchanging tasks. The system may include a client device 110 through which a user can access information related to tasks and customers over a communications network 118. The communications network can be a local area network (LAN), wide area network (WAN), or the internet. A graphical user interface 112 can be provided to the user using the client device 110 to access the task, customer, and related information located on a separate computing device 120. A client device 110 with a graphical user interface 112 may be used by either a service provider or a customer.

Parameters for a task that the customer desires to be performed can be received by the graphical user interface 112 of the client device 110. For example, the customer may type, speak, write, or select task parameters that the client device 110 can capture. Payment for the task selected by the customer may also be supplied via the graphical user interface. In one example, payment via a credit card or debit transaction is collected before the task is assigned to a service provider for performance. The client device may include a processor 114 and a memory module 116. A client device 110 may be a device such as, for example, a desktop computer, a laptop, a tablet, a mobile device, a television, a cell phone, a smart phone, a hand held messaging device, a set-top box, a gaming console, a personal data assistant, an electronic book reader, heads up display (HUD) glasses, or any device with a display that may present the graphical user interface 112.

The parameters for a task collected by the client device 110 can be sent to a computing device 120. The computing device 120 may be provided with modules for providing and managing tasks and customers. Additional related functions for communication, fixed pricing, service provider selection, task exchange, and task valuation can also be provided, as will be described later. The computing device 120 may be a single server, a distributed server environment, a server farm, or any computing device or group of computing devices that may service requests from other computing devices or programs. In addition, the computing device may include one or more processors 142 and memory modules 144.

The parameters that are requested from the customer can be collected and used by a task definition module 122. The task definition module 122 can also obtain a task definition for a task which describes task details to be performed for a customer. In addition, the task definition module 122 can access the task definitions 130 located in the data store 128, and the task definitions may include specific definitions of what procedures are going to be undertaken for a task. For example, the task definition can define a mowing task as: 1) cutting grass and 2) blowing loose grass off sidewalks. The task definition may also include a question template to send to customers to obtain the factual task parameter information that is desired to be captured from the customer about a task type. The customer's replies and specific factual data collected in response to the questions about tasks can be stored in the task details 134 data store. The data store 128 may refer to any device or combination of devices capable of storing, accessing, organizing, and/or retrieving data, which may include any combination and number of data servers, relational databases, object oriented databases, simple web storage systems, distributed storage systems, data storage devices, data warehouses, flat files, and data storage configuration in any centralized, distributed, or clustered environment. The storage system components of the data store may include storage systems such as a SAN (Storage Area Network), cloud storage network, volatile or non-volatile RAM, optical media, or hard-drive type media.

A fixed price for a task may be determined based on the parameters collected about the task. Statistical price data for tasks may also be used in calculating the fixed price for a task. As mentioned earlier, the fixed price is the fee under which a service provider is expected to perform the task for the customer after the service provider has received the task assignment. In one example, the service provider may simply work on tasks automatically assigned to the service provider's schedule, or in another example, the service provider may choose to approve work assignments in advance of scheduling. A significant portion of the retail fixed price charged to the customer can be paid to the service provider and a smaller portion of the fixed price may be retained by the entity operating the technology described in this description. For example, the fixed price can be calculated using a fixed price module 124 to set a task price for the task based on the task details and statistical price data identified in the statistical information 136 data store. The fixed price can be calculated, in part, using the task details 134 provided by the customer, as stored in the data store 128. These task details may include one or more of the following details: time since last service performed, square dimensions of project, current state or quality of project, desired state or quality of project, number of hours service may be performed, distance to be traveled, number of units to be transported, average amount of time similar tasks have historically consumed, average cost of parts similar tasks have historically consumed, number of levels or stories of a structure, number of rooms in a structure, square dimensions of a structure, the presence of exterior improvements such as a swimming pool, hot tub or basketball court, the desired start date, the desired completion date, whether a specific time or an approximate time is desired for performance of the service, the number of legal steps required by law, the grade or style of materials used, the frequency of recurrence, the depth or quantity of material to be moved or removed, the linear dimensions of project, etc. Once calculated, the fixed price may be stored in the data store 128 as a task price 132.

Additional input parameters may also be obtained automatically from third parties. For example, a house lot size, square footage of the house, number of bedrooms and bathrooms, and related real property information can be obtained for a real estate information service provider. Similarly, mapping data and address correction data can be obtained from a mapping information service provider. Weather data can be obtained (e.g., for snow clearing predictions) including snow accumulation hourly actual measurements along with future predictions, temperature and humidity for estimating snow ablation from a weather information source.

Service provider feedback about customers and tasks can help refine task pricing. In some cases, there may be unexpected aspects of the tasks that occur with certain customers or certain types of tasks. For example, edging a customer's lawn may be more difficult the first time where the customer has a very overgrown lawn. Customer feedback about service providers (quality, timeliness, speed, etc.) may also be used to refine the method of matching service providers with tasks. In addition, customer feedback can also be used in refining the task pricing.

As discussed, a service provider may be selected from among the plurality of service providers to perform the task. The service provider selection can take place using the service provider selection module 126. Criteria for selecting a service provider may include using at least one of the following: a distance between the service provider and customer, time slots made available by the service provider, a skill level of service requested, previous performance feedback of the service provider from prior customers, quality tier of a service provider, etc. Other criteria or metrics about service providers may also be used in selecting a service provider, as desired.

The customer and the service provider can be notified of the service provider selection using the notification module 127. In one example, the notification module 127 may prepare a web page or a web application page to be sent to the customer. Alternatively, a notification can be sent through the graphical user interface 112 on the client device 110 using an application on the client device 110. Other types of notifications may include: emails, instant messages, text messaging, or any other message type that can be received by the customer. Once the service provider has been selected, then the service provider can be scheduled to perform the task. More specifically, the task can be added to an available time slot on the service provider's calendar, and the customer can be notified of the scheduled task time. The notification module can also prepare other network pages, web pages, or web application pages to communicate other information to the client device 110.

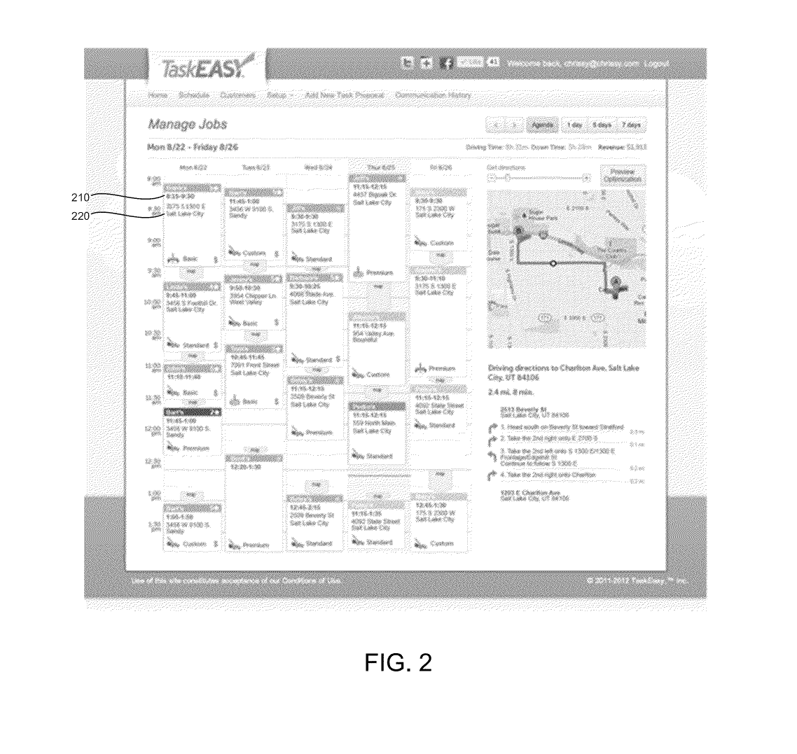

The scheduling of the tasks and customer visits can be performed electronically, as described earlier. The computing device 120 of FIG. 1 may include a scheduling module 150 to schedule tasks purchased by a customer on a service provider's calendar once the service provider has accepted the task. These tasks are then shared with a service provider by way of a task schedule FIG. 2. A task schedule for a work day is viewable by a service provider on a mobile device or client device with a user interface that may be in communication with the computing device 120 (FIG. 1). This schedule may provide time 210 and locations 220 for tasks purchased by a customer and the tasks may be performed by

The system illustrated by FIG. 1 can also provide tools to a service provider for: managing the service provider's customers, managing the service provider's team members, monitoring tasks and schedules, managing finances, finding new customers and other service provider related functions.

One useful function of this technology is the ability to monitor and verify a service provider's presence at a task location. Monitoring may be accomplished through the use of a mobile device with a display that may present the graphical user interface 112. The mobile device may have a camera that may provide a timestamp representing when a task may be started, completed, and times in-between. Among other possible hardware peripherals, the mobile device may also have a GPS (Global Positioning System) that records GPS coordinates of the mobile device in conjunction with any additional information that the device gathers. The mobile device may share collected information through a communication network 118 with a data store 128 of a computing device 120 (FIG. 1), or the information may be transferred to a computing device 120 at a later time.

For example, a task may be assigned to a service provider. The task assignment may be for lawn care that a customer within the service provider's area wishes to be performed between the times of 8:00 AM and 9:00 AM. Using a client device 110, the service provider may view a task schedule belonging to the service provider to receive the task details 134 of the task assignment. Details may include, the location address, the price to be paid for completion of the task, the type of task to be completed, etc. With this information, the service provider then may go to the customer location.

When the service provider arrives at the customer location, a geographic location 138 of the service provider may be captured by the client device 110 along with a timestamp 140 and then the client device 110 may send the information to the computing device 120 over the communication network 118. The geographic location 138 and timestamp 140 together may represent a geographic location capture time, indicating that the service provider was at the customer location at that time.

Capturing of the service provider's geographic location and a related time may be performed manually or automatically (i.e., by a program or application). Geographic boundaries may also be electronically set around a location that a service provider is scheduled to visit. These boundaries may be set automatically since the coordinates of the location where the service provider is scheduled to provide services is known. For example, a boundary may be set that is or one-tenth of a mile away from the service location on each side of the service location (e.g., three or more sides). Further, the boundaries may be set as the boundary of the property where the service provider is working or the boundary may be farther away from the task location as desired. In addition, the geographic location information provided automatically or manually by the service provider's mobile device may also be used to determine whether the service provider is within or outside the designed geographic boundaries. Thus, data can be collected regarding whether a service provider is in a location for a long enough time to perform the service in the task location. Whether a service provider leaves an area for an unexpected period of time and then returns to the area may also be recorded and reported to a customer. Communications via text message, email, recorded voice call, instant message, etc., may also be automatically generated and provided to the customer when the service provider is on-site, when the service provider leaves, when the service provider leaves for an unexpected period of time or if the service provider never arrives at the location.

In another example, the geographic location 138 and timestamp 140 may be captured during a time period that the service provider is scheduled to be at the customer location performing the task. As an illustration, the service provider may have been scheduled to be at the client location between the times of 8:00 AM and 9:00 AM. Any time during the hour that the service provider is scheduled to be at the customer location performing the task, the client device 110 may capture the geographic location 138 and timestamp 140 showing that the service provider was in fact at the customer location during that time period and then send the information to the computing device 120 via the communication network 118.

In another example, the client device 110 may capture a first geographic location 138 and a first timestamp 140 at the beginning of a time period the service provider is scheduled to perform the task. To illustrate, the service provider may be scheduled to be at a customer location at 8:00 AM. When the service provider arrives at the customer location at 8:00 AM, the client device then captures a first geographic location 138 and a first timestamp 140 showing that the service provider arrived at the customer location on time.

Somewhat related to the previous example, the client device 110 may capture a second geographic location 138 and a second timestamp 140 at the end of a time period that the service provider is scheduled to perform a task. Therefore if the service provider is scheduled to be at the customer location until 9:00 AM, then the client device can capture the geographic location 138 and timestamp 140 at 9:00 AM to show that the service provider was in fact at the client location until that time. More specifically, the time interval that the service provider was located at the customer location can also be recorded. This time interval can be compared to a database of task statistics to determine whether this task time is within a specific confidence range. If the time interval is within the specific confidence time range, then no further action may be taken by the computing device 120. If the time interval is outside the specific confidence time range, then this task can be flagged for customer review.

In addition to the client device capturing information at appointed times, the service provider may initiate the capture of a geographic location 138 and timestamp 140 manually. Thus, for example, if the service provider arrives at a customer location and desires to create a record of the service provider having been there, the service provider may activate the client device to capture the geographic location 138 and timestamp 140 and send the information to the computing device 120 over the communication network 118.

Capturing the geographic location (GPS location) and timestamp may also be performed when a service provider approaches within a predefined distance of the service location as a beginning time, and another geographic location and timestamp may be captured when the GPS location of the service provider moves more predefined distance away from the service location as the ending time. For example, the predefined distance may be 100 feet, 500 feet, a fraction of a mile (or kilometer) or another predefined distance. The predefined distance may be vary depending on the type of task, location or other relevant factors.

Capturing a GPS location and related timestamp when a service provider approaches or leaves a work location can provide the customer with automated start and end times for the task in addition to manual start and end times that the service provider might provide. The captured data may also allow a comparison of start and end times automatically captured via GPS, start and end times provided at the beginning and end of the task by the service provider, and start and end times that might be manually input later (by a manager or by the service provider himself as a correction to the original values collected). If the three pairs of data differ significantly, then this difference may be indicative of a problem, particularly if the start/end pairs in the less automated collection methods create a longer task time then the automatically collected methods. For example, a service provider is unlikely to have performed 90 minutes of work if the service provider was verifiably at a location for 70 minutes. It may be less alarming if the opposite were the case, as the service provider might be honestly reporting that a lunch break was taken or another customer phone call occurred while the service provider was on-site performing work.

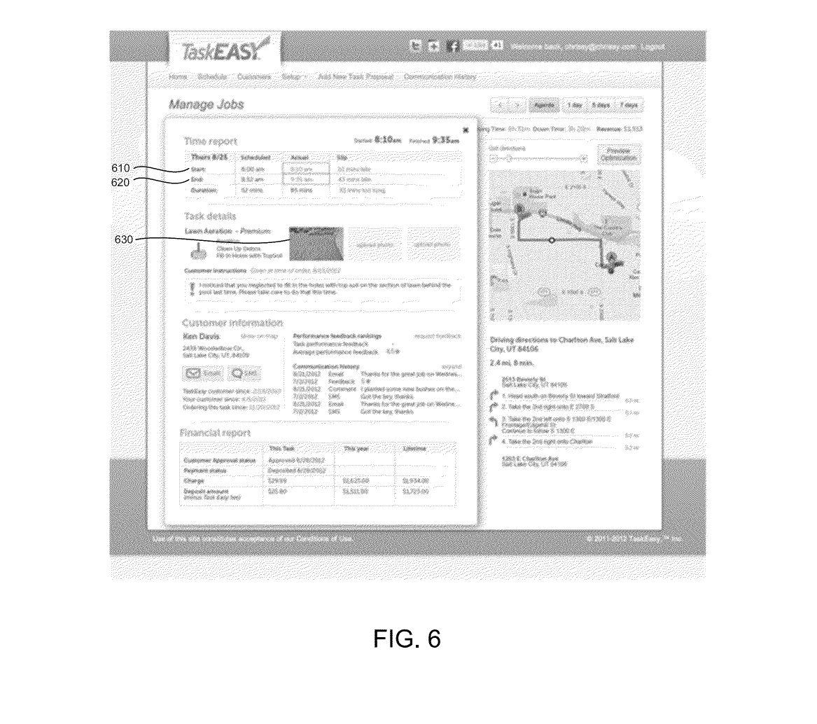

In the next example the client device 110 may collect geographic location data, such as GPS coordinates, or a location as determined by wireless networks or mobile networks from a service provider to verify that the service provider has visited a task location. Also, photographic data may be acquired that verifies the service provider has visited a location and completed the task. For example, a smart phone can collect data at the site of the task when the service provider is at the location to perform the task. Photographs 630 (FIG. 6) with timestamps from the work site before and after the work has been performed on the photos can be posted and this data can be linked with the work order itself. Collecting verification data allows the customer and others to verify that the service provider was at the physical location performing the task at the specified location and time, even when the customer was not physically at the location.

This quality assurance process can reduce the need to have the customer physically review the work being done, and may provide enough information in a data store to enable others (i.e., customers and managers) to remotely and electronically check the completion of work and inspect the quality of work. The photographic data may contain a beginning timestamp 610 (FIG. 6) and the task location before the task is performed can be shown 630. Another photograph may be acquired that contains an ending timestamp 620 (FIG. 6) and the task location after the task is performed can include a photograph to create a record of task completion. As discussed earlier, the beginning and ending timestamps of the photographic data may then be used to compute a task completion interval and enable the task completion time to be compared to an expected task time. The expected task time that is used to compare with the task completion interval from above, may be obtained by using task details 134 (FIG. 1) and statistical information 136 associated with the task and task details 134. As the statistical information 136 may be updated, the expected task time may also be updated. For example, when a service provider arrives on site, the service provider may use a mobile computing device to take a first picture containing a first timestamp of the site before any work is initiated. Upon completion of the task, the service provider may take a second picture with an associated a second timestamp. The photographic data is sent to the computing device where the task completion interval may be computed based upon the first and second timestamps. The result is then compared to an expected task time, the expected task time having been determined from the task details 134 and the statistical information 136 for this particular task. As the statistical information 134 is updated, the expected task time may also be updated.

In a statistical compliance example, fees assessed to service providers for using the technology may be based, in part, on an amount of auditing data the service provider is willing to properly provide. For example, if GPS data, time data, and photo data are automatically provided by a service provider at both the start and end times of a task, then a reduced fee might be charged to the service provider for using the technology and complying with desired auditing procedures. If the desired auditing elements are provided, but some of the auditing elements are manually entered by the service provider, then the fee charged to the service provider may be increased as compared to a service provider who supplies the auditing data automatically. If one or more of these auditing elements are missing, then the fees charged to the service provide may be further increased as compared to the service provider who supplies some auditing data manually. In another configuration, incentives may be provided to service providers who comply with the auditing procedures. Such incentives may be cash incentives or credit incentives within the described technology.

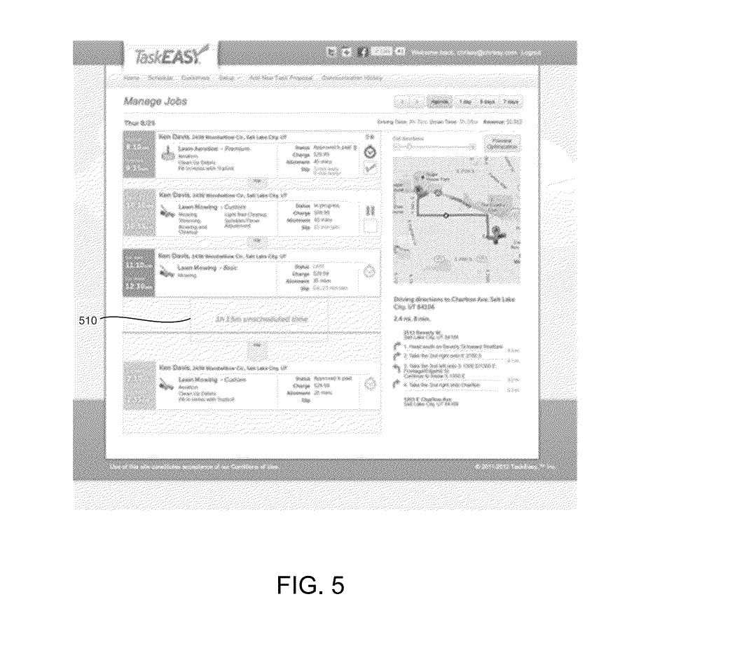

In the next example, using a client device 110, a service provider may have the ability to submit a new task with a price bid to the computing device 120 which may then made available to a customer for approval. This allows the service provider to generate new business by identifying work that may need to be performed for the customer and relieves the burden on the customer of identifying every task that may be valuable for the service provider to perform. In addition, while the service provider is at the task location, the customer may have the ability to receive the new task and approve the new task. The new task then may be scheduled to follow the current task for which the service provider is at the location to perform, if a time slot is available following the current task 510 (FIG. 5). The time slot may be a contiguous time slot or the time slot may be near in time to the time slot for the current task.

Even if the new task is for a separate customer, the new task may be scheduled after the current task when the new task is in geographic proximity and in a time proximity to current task that provides efficiency for the service provider. In other words, the new task may or may not be at the same location of the current task. However, a task that is at the same location as the current task can provide significant efficiencies for the service provider.

While at a task location, a service provider may have the ability to modify certain orders and tasks. For instance, a service provider may be able to submit a change order to the customer for approval while the service provider is at the task location using a client device 110 and sending the change to the computing device 120. A customer may also be able to submit change orders through a user interface of the system. This change order user interface can be accessible via a mobile device or another computing device. A change order system allows the customer to make decisions away from the location where the tasks are being performed or on-site while visiting locations where the tasks can be performed. More specifically, a service provider who is onsite completing a task can identify recommended tasks or services that might be performed and submit bids for recommended tasks through the system. For example, if a service provider who is mowing a lawn identifies flower beds that may be weeded, then the service provider can submit a bid for doing the weeding work. Similarly, if a broken water sprinkler is identified, then this repair can be submitted through the system. Once a customer reviews the bid, the customer may accept or reject the bid and the associated price. If the service provider is able to do the task and the customer accepts the job, then the service provider has increased the amount of work available and the customer is happy because the customer receives the desired task. If the service provider is not able to perform the work for whatever reason, then the task can be referred to another service provider. Further, the original service provider who identified the task or problem can be compensated with credits for the referral as described above.

Also, using a client device 110, the service provider may submit corrected task details that the service provider has defined to revise the task price, while the service provider is at the task location. After the service provider has submitted the changes, the customer may approve and pay based upon the corrected task details.

As discussed earlier, a customer may have a service provider assigned to the customer's task in order to complete the task. The scheduling of the task and subsequent notification of the service provider as to when, where and at what price the task may be performed, can be using a mobile device (e.g., smart phone or tablet). A service provider may be also be notified via the mobile device about an initial task and/or any tasks added later. The service provider's mobile device may be used for rescheduling of an initial task. Furthermore, the service provider's mobile device can be used for rescheduling of subsequent assignments to accommodate an added task at the given location.

An added task may be a task identified by a service provider who also undertakes the newly identified task, or an added task may come from another service provider who is referring or selling a newly created task to the service provider. A service provider may accept task assignments and create task assignments from a mobile device and since many mobile devices can be identified as being uniquely assigned to an individual or organization, such task acceptances can be proved to be accepted by a specific individual or person. For example, a unique MAC address, cellular telephone number or cellular modem may uniquely identify a mobile device. Thus, a service provider's acceptance of a task may be as contractually binding as a signature or a similar acceptance. In other words, the service provider can accept a newly identified task via the mobile device and the acceptance can be recorded as a contract. In addition, the GPS-based tracking, photographic data for before task completion and after task completion and elapsed time may be used in conjunction with the uniquely identifiable nature of many mobile devices to prove the formation of a contract or which individual actually performed the task.

In addition, a service provider's current location, as determined by the mobile device and a knowledge of the estimated time before a task is completed may also be used in the scheduling of a short-notice request by a different customer that is proximate to the service provider.

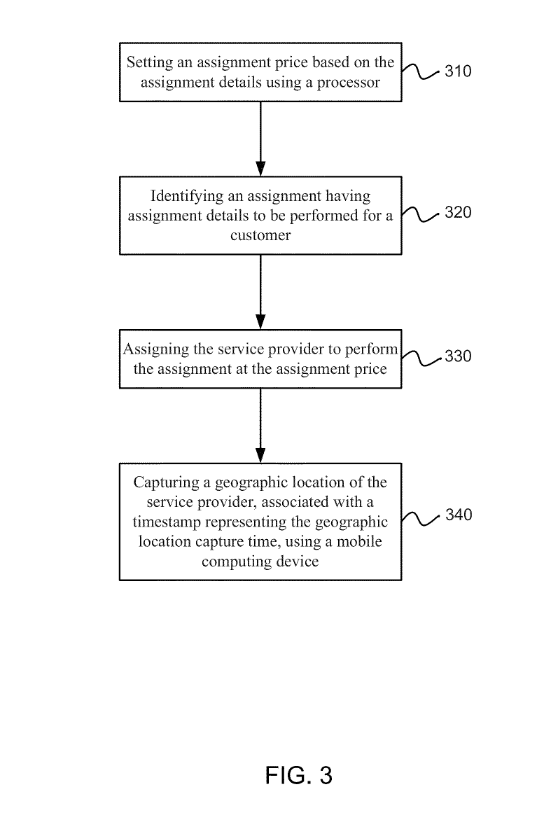

Referring now to FIG. 3, a method is illustrated for electronically verifying a service provider presence at an assignment location. Starting with block 310, an assignment price can be set based upon the assignment details. As discussed earlier, the pricing of the assignment or task may be a price that is calculated using existing facts about the service and statistical data known about service prices in a geographical area, etc. This information may then be used to set the assignment price.

In block 320, an assignment that is to be performed for a customer that has assignment details is identified. This identification may be based upon a number of different variables. For example, the identification of the assignment may be based on the geographic location of the assignment, the work type of the assignment, the assignment time, or the service provider willing to perform the assignment, etc.

In block 330, after an assignment has been identified in the step above, the assignment may be assigned to a service provider who may be willing to perform the assignment at the assignment price. This may be a service provider who regularly works in or near the geographic area where the assignment is to be performed.

In block 340, after the service provider has accepted the assignment and travels to the assignment location, a geographic location and a timestamp associated with the geographic location may be captured using a mobile computing device that the service provider has in the service provider's possession. The geographic location and associated timestamp may function as information that represents a geographic location capture time, and may be used to verify that the service provider was at the assignment location.

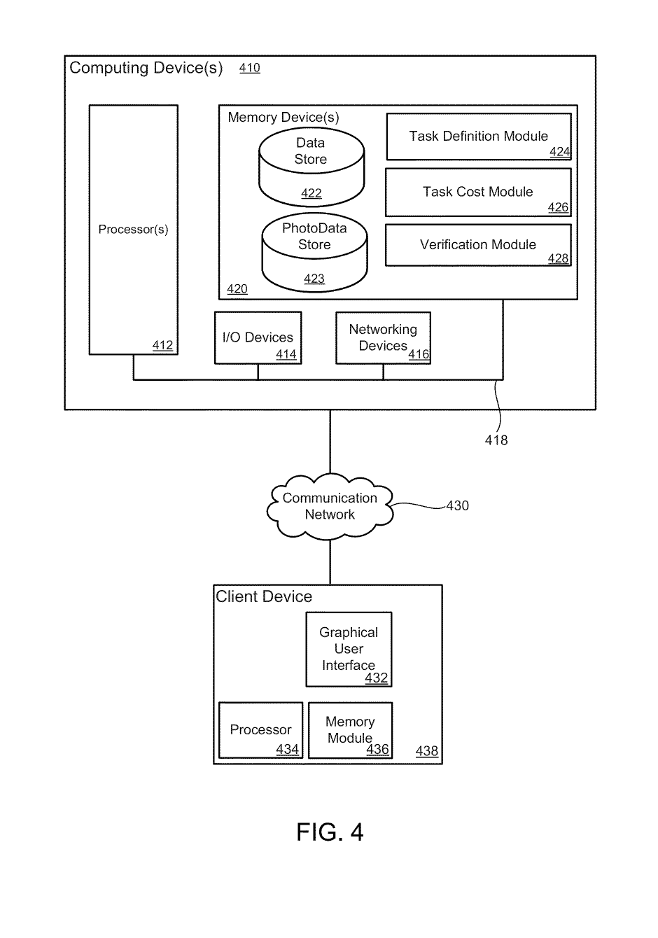

FIG. 4 illustrates a computing device 410 on which modules of this technology may execute. A computing device 410 is illustrated on which a high level example of the technology may be executed. The computing device 410 may include one or more processors 412 that are in communication with memory devices 420. The computing device may include a local communication interface 418 for the components in the computing device. For example, the local communication interface may be a local data bus and/or any related address or control busses as may be desired.

The memory device 420 may contain modules that are executable by the processor(s) 412 and data for the modules. Located in the memory device 420 are modules executable by the processor. For example, a task definition module 424, a task cost module 426 and a verification module 428 and other modules may be located in the memory device 420. The modules may execute the functions described earlier. Specifically, the verification module can verify that the service provider is performing a purchased task by using a mobile device to capture geographic location data or photographic data about the tasks performed by the service provider. A data store 422 and a photographic data store 423 may also be located in the memory device 420 for storing data related to the modules and other applications along with an operating system that is executable by the processor(s) 412.

Other applications may also be stored in the memory device 420 and may be executable by the processor(s) 412. Components or modules discussed in this description that may be implemented in the form of software using high programming level languages that are compiled, interpreted or executed using a hybrid of the methods.

The computing device may also have access to I/O (input/output) devices 414 that are usable by the computing devices. An example of an I/O device is a display screen 430 that is available to display output from the computing devices. Other known I/O device may be used with the computing device as desired. Networking devices 416 and similar communication devices may be included in the computing device. The networking devices 416 may be wired or wireless networking devices that connect to the internet, a LAN, WAN, or other computing network.

The components or modules that are shown as being stored in the memory device 420 may be executed by the processor 412. The term “executable” may mean a program file that is in a form that may be executed by a processor 412. For example, a program in a higher level language may be compiled into machine code in a format that may be loaded into a random access portion of the memory device 420 and executed by the processor 412, or source code may be loaded by another executable program and interpreted to generate instructions in a random access portion of the memory to be executed by a processor. The executable program may be stored in any portion or component of the memory device 420. For example, the memory device 420 may be random access memory (RAM), read only memory (ROM), flash memory, a solid state drive, memory card, a hard drive, optical disk, floppy disk, magnetic tape, or any other memory components.

The processor 412 may represent multiple processors and the memory 420 may represent multiple memory units that operate in parallel to the processing circuits. This may provide parallel processing channels for the processes and data in the system. The local interface 418 may be used as a network to facilitate communication between any of the multiple processors and multiple memories. The local interface 418 may use additional systems designed for coordinating communication such as load balancing, bulk data transfer and similar systems.

The communication network 430 may represent any number of networks including those that may be a local area network (LAN), wide area network (WAN), or the internet. The client device 438 may represent multiple devices, for example, a desktop computer, a laptop, a tablet, a mobile device, a television, a cell phone, a smart phone, a hand held messaging device, a set-top box, a gaming console, a personal data assistant, an electronic book reader, heads up display (HUD) glasses, or any device with a display that may present the graphical user interface 432. The graphical user interface 432 of the client device 438 may enable a user to type, speak, write, or select task parameters that the client device 438 may capture. The client device 438 may include a processor 434 and a memory module 436.

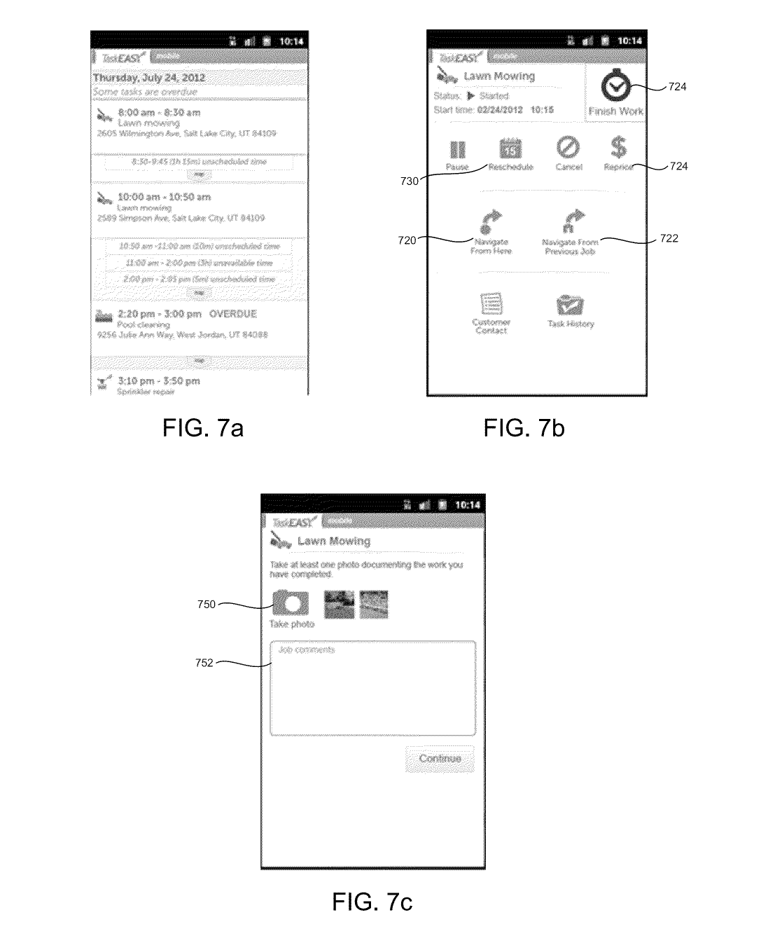

FIGS. 7a-7c illustrate user interface screens for mobile devices depicting functions related to performing tasks. FIG. 7a illustrates a daily task schedule for a service provider on a mobile device. This screen allows the service provider to have an automated schedule through the mobile device. This schedule can re-calculate task appointments as previous tasks take a longer or shorter time than expected.

FIG. 7b illustrates an interface for tracking when a task is finished 724. Additional functions are provided for rescheduling of a task 730, re-pricing of a task 724, navigating to a next task 720, and navigating from a previous task 722.

FIG. 7c illustrates a user interface to enable a service provider to capture one or more photos related to a specific task. The photos can document a location before a task has been started, document the completion of the task, or document other aspects of a task.

A service provider can user a mobile device (e.g., a smart phone) to identify a task that the current service provider cannot carry out, due to lack of capability (skills, tools, time, etc.). Where the service provider identifies a new task that may need to be performed by the user, the service provider can photograph an area where the task may take place and/or write a description of the task that can be captured by the mobile device. In addition, a geographic location (e.g., GPS coordinates) may be captured when the new task is created. The photographic record, task description, and the geographic location may become part of the information used to price the task for another service provider who carries out the work. This task may be presented to other service providers using the technology and another service provide may purchase this task with system credits or cash. This allows the service provider who identified the task to earn system credits or cash for the task referral.

In some situations, a service provider may damage the customer's property in some way. For example, a service provider may break an expensive vase in a home that is being cleaned. A mobile device may be user to document and submit a damage claim through the technology for damage caused by the service provider. This documentation can be used to facilitate submitting an insurance claim for the damaged property.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

1. A method for electronically verifying service provider presence at a task location, comprising:
under control of a processor and memory configured with executable instructions,
identifying a task assignment having task details to be performed for a customer;
setting a task price for a task based on the task details using a processor;
assigning the task to a service provider to perform the task at the task price; and
capturing a geographic location of the service provider, associated with a timestamp representing the geographic location capture time, using a mobile computing device.

2. The method as in claim 1, further comprising capturing the timestamp and the geographic location during a time period the service provider is scheduled to be performing the task.

3. The method as in claim 1, further comprising capturing a beginning geographic location and the timestamp automatically when the service provider comes within a predefined distance of a physical location where the task is to be performed.

4. The method as in claim 3, further comprising capturing an ending geographic location and timestamp automatically when the service provider is a predefined distance from the physical location where the task is to be performed while leaving the physical location.

5. The method as in claim 1, further comprising capturing a first timestamp and a first geographic location at a beginning of a time period the service provider is scheduled to perform the task.

6. The method as in claim 5, further comprising capturing a second timestamp and a second geographic location at an end of a time period the service provider is scheduled to perform the task.

7. The method as in claim 1, further capturing the geographic location and the timestamp as initiated by the service provider through the mobile computing device.

8. The method as in claim 1, further comprising collecting geographic location data from a service provider to verify the service provider has visited a task location to complete the task.

9. The method as in claim 1, further comprising collecting photographic completion data from a service provider to verify the service provider has visited a location to complete the task.

10. The method as in claim 1, further comprising acquiring photographic data with a beginning timestamp for a task location before the task is performed.

11. The method as in claim 1, further comprising acquiring photographic data with an ending timestamp for a task location after the task is performed to form a record of task completion.

12. The method as in claim 11, further comprising computing a task completion interval using the beginning timestamp and the ending timestamp for comparison to an expected task time.

13. The method as in claim 12, further comprising obtaining the expected task time using the task details and statistical information associated with the task and task details.

14. The method as in claim 13, further comprising updating the expected task time as the statistical information is updated.

15. The method as in claim 1, further comprising allowing a service provider to submit a new task with a price bid for customer approval.

16. The method as in claim 15, further comprising enabling the customer to receive the new task and approve the new task while the service provider is at the task location.

17. The method as in claim 16, further comprising scheduling the new task for the customer to follow the task for which the service provider has traveled to the task location, when a contiguous scheduling slot is available.

18. The method as in claim 16, further comprising scheduling the new task to follow the task for which the service provider has traveled to the task location, when the new task is in geography proximity of the task.

19. The method as in claim 16, further comprising enabling the service provider to accept the new task via a mobile device and the acceptance is recorded as a contract.

20. The method as in claim 1, further comprising allowing a service provider to submit a change order to the customer for approval while the service provider is at the task location.

21. The method as in claim 1, further comprising submitting corrected task details as defined by the service provider to revise the task price while the service provider is at the task location.

22. The method as in claim 21, wherein the customer can approve and pay for the corrected task details.

23. The method as in claim 1, further comprising allowing a service provider to submit an insurance claim for damage the service provider caused via a mobile device.

24. The method as in claim 23, further comprising documenting the insurance claim for damage caused by the service provider using a photograph and location captured by the mobile device at a location where the damage occurred.

25. A system for customer exchange, comprising:
a task definition module to obtain a task definition for a task having task details to be performed for a customer;
a task cost module to set a task price for the task based on the task details and statistical price data;
a verification module to capture a geographic location of the service provider, associated with a timestamp representing the geographic location capture time, using a mobile computing device.

26. The system as in claim 25, further comprising a photographic data store to store photographs taken at the time the geographic location is captured.

27. The system as in claim 25, further comprising a mobile computing device to capture the geographic location, timestamp and photographs for the task.

28. A method for electronically verifying a service provider's presence at an assignment location, comprising:
under control of a processor and memory configured with executable instructions,
setting an assignment price based on the assignment details using a processor;
identifying an assignment having assignment details to be performed for a customer;
assigning the service provider to perform the assignment at the assignment price; and
capturing a geographic location of the service provider, associated with a timestamp representing the geographic location capture time, using a mobile computing device.
